(19) United States
(12) Patent Application Publication
(10) Pub. No.: US 2026/0252036 A1
(43) Pub. Date: Aug. 27, 2026

(54) System and Method for Determining Device Utilization

(71) Applicant: Rockwell Automation Technologies, Inc., Mayfield Heights, OH (US)

(72) Inventor: Jonathan Hoffman, Milwaukee, WI (US)

(21) Appl. No.: 19/062,291

(22) Filed: Feb. 25, 2025

(51) Int. Cl. G05B 6/02

(52) U.S. Cl. CPC G05B 6/02

(57) ABSTRACT

A method for real-time determination of steady state device utilization includes receiving a cycle start signal at a controller for a controlled device and measuring a feedback signal from a sensor configured to monitor the controlled device through a cycle of operation. The feedback signal corresponds to an operating state of the controlled device. An average value of the feedback signal is obtained for the cycle of operation, and the steady state device utilization of the controlled device is determined. The controlled device achieves the steady state device utilization over multiple future cycles, and the steady state device utilization is determined in real-time as a function of an average value obtained during the cycle of operation for which the feedback signal is measured.

### BACKGROUND INFORMATION

The subject matter disclosed herein relates to a system and method for determining steady state utilization of a device based on a cyclic load. More specifically, an operating condition of the device is measured over one cycle of the cyclic load and the steady state utilization is determined as a function of the measured operating condition.

As is known to those skilled in the art, industrial control systems utilize one or more controllers to achieve desired operation of a controlled machine or process. The controller(s) receive input signals from sensors on the controlled machine or process, where the input signals correspond to an operating condition of the controlled machine or process. A control program executing in the controller uses the input signals to generate output signals for actuators on the controlled machine or process to achieve a desired operating state in response to the measured operating conditions.

As is also known to those skilled in the art, the controller(s) may monitor the input signals to identify an unsafe or undesired operating state. For example, a temperature sensor generates a feedback signal corresponding to a measured temperature of a device or location within the controlled machine or process. When the temperature reaches or exceeds a predefined setpoint, the controller generates a warning message for a technician indicating the high temperature. If the temperature continues to rise, the control program may generate output signals to alter or shut down operation of the controlled machine or process to prevent a continued increase in temperature.

Temperature, like many other control variables, may not change rapidly. An industrial control system may operate for minutes or hours before the measured temperature, or other measured variable, exceeds a warning level or a maximum value. If the industrial control system routinely exceeds the warning level or maximum value, a technician may need to modify a control parameter or otherwise adjust operation of the controlled system to prevent operation at the undesired level. However, it may take a similarly long time for the industrial control system to cool down or return to a safe operating state at which a technician may make the required modifications. Further, it may take several rounds of starting up the controlled machine or process, observing operation, and shutting down the controlled machine or process for further adjustment before acceptable operation is achieved.

Thus, it would be desirable to provide an improved method and system for determining device utilization.

It is a further feature of the present invention to determine device utilization without waiting for the controlled device or system to reach a steady state operating condition.

### BRIEF DESCRIPTION

According to one embodiment of the invention, a method for real-time determination of steady state device utilization includes receiving a cycle start signal at a controller for a controlled device and measuring a feedback signal from a sensor configured to monitor the controlled device through a cycle of operation. The feedback signal corresponds to an operating state of the controlled device. An average value of the feedback signal is obtained for the cycle of operation, and the steady state device utilization of the controlled device is determined. The controlled device achieves the steady state device utilization over multiple future cycles, but the steady state device utilization is determined in real-time as a function of an average value obtained during the cycle of operation for which the feedback signal is measured.

According to another embodiment of the invention, a system for real-time determination of steady state utilization of a controlled device includes a controlled device and a controller. The controlled device receives an operation profile that varies at a periodic interval. The controller is configured to receive a signal corresponding to an operating state of the controlled device and to detect a cycle start signal. The cycle start signal corresponds to a beginning of the periodic interval over which the operation profile of the controlled device varies. A steady state device utilization of the controlled device is determined, where the controlled device achieves the steady state device utilization over multiple cycles. The steady state device utilization is determined as a function of the signal corresponding to the operating state of the controlled device measured over one cycle of operation for the controlled device.

According to still another embodiment of the invention, a motor drive configured to control operation of a motor includes a power section and a control section. The power section is configured to output a voltage to the motor for desired operation of the motor. The control section is configured to receive a command signal at a periodic interval corresponding to the desired operation of the motor, receive a feedback signal from a sensor, and detect a cycle start signal. The feedback signal corresponds to an operating state of the motor, and the cycle start signal corresponds to a beginning of the periodic interval. A value of the feedback signal is determined for steady state operation, where steady state operation is achieved over multiple periodic intervals and the value of the feedback signal for steady state operation is determined after a single periodic interval.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is an exemplary control system in which input data at an encoder is synchronized;

FIG. 2 is a block diagram representation of a portion of the control system of FIG. 1;

FIG. 3 is a graphical representation of cyclic operation of a controlled load along with a start of cycle signal;

FIG. 4 is a graphical representation of predicted versus actual utilization of a controlled device during cyclic operation; and

FIG. 5 is a flow diagram illustrating the steps for determining steady state device utilization according to one embodiment of the invention.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes an improved method and system for determining device utilization. A controller receives a cycle start signal corresponding to a fixed point within a periodic cycle of operation for the device. According to one aspect of the invention, the cycle start signal indicates the beginning of each cycle of operation. However, the cycle start signal could correspond to any point within the periodic cycle as long as it is generated at the same point within each cycle. The controller measures a feedback signal from a sensor, where the feedback signal corresponds to an operating state of the controlled device. The feedback signal may be continually monitored; however, the value of the feedback signal over a single cycle of operation is used to predict a steady state value of the measured operating condition. Alternately, the controller may monitor a reference signal generated within the controller. In some controlled systems, portions of control may execute in an “open-loop” manner. A reference signal is generated to achieve desired operation of the controlled system. However, no sensor is present to generate a feedback signal corresponding to the reference signal. It may, therefore, be desirable to monitor the reference signal rather than a feedback signal corresponding to an operating state of the controlled system. According to another aspect of the invention, an average value of the monitored signal over a single cycle is determined. This average value corresponds to the steady state value, which will result from continued operation of the device over multiple cycles of operation. Thus, it is a further feature of the present invention to determine device utilization without waiting for the controlled device or system to reach the steady state operating condition.

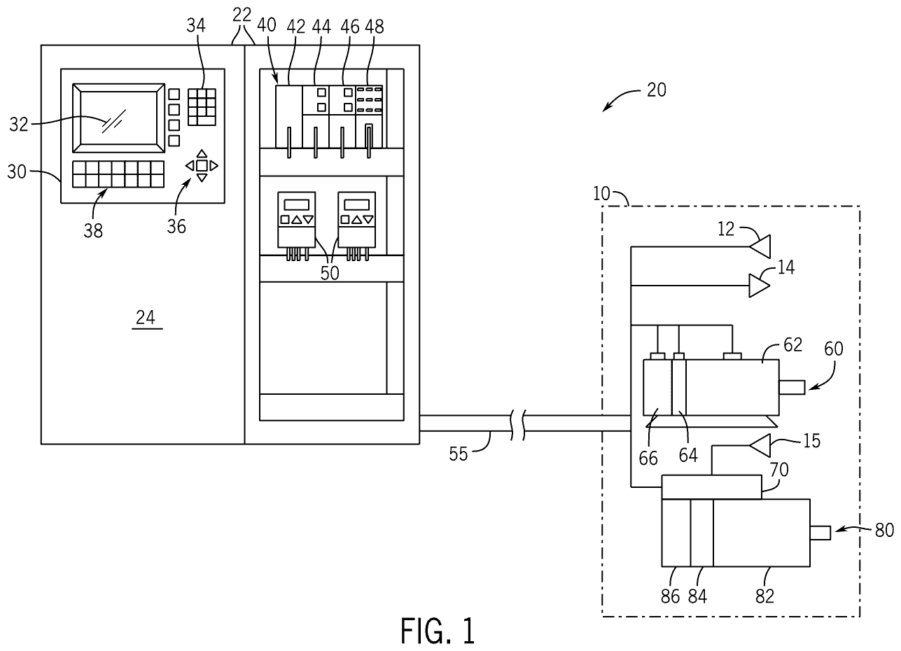

Referring initially to FIG. 1, an industrial control system 20 may include control cabinets 22 housing control devices. The control cabinets 22 may be located in a dedicated control room or out in a manufacturing environment proximate a machine or process 10 to be controlled by the control system 20. The illustrated embodiment includes a first control cabinet with a closed door 24 on which a human machine interface (HMI) 30 is mounted, and a second control cabinet with a door removed for illustration purposes. The control cabinets 22 include doors to provide an enclosure in which the control devices are protected from the ambient environment in which the control cabinet is located.

The HMI 30 is typically an industrial computer hardened for use in a manufacturing environment. The HMI 30 is in communication with an industrial controller 40 to provide information to a technician regarding the controlled machine or process 10. A display 32 allows data to be shown to the technician and may be a touch screen to additionally receive input from the technician. Additional user interface devices are provided on the HMI such as a numerical keypad 34, a directional keypad 36 for menu navigation, and preprogrammed function keys 38, providing rapid access to various screens, menus, or data as required by the application requirements.

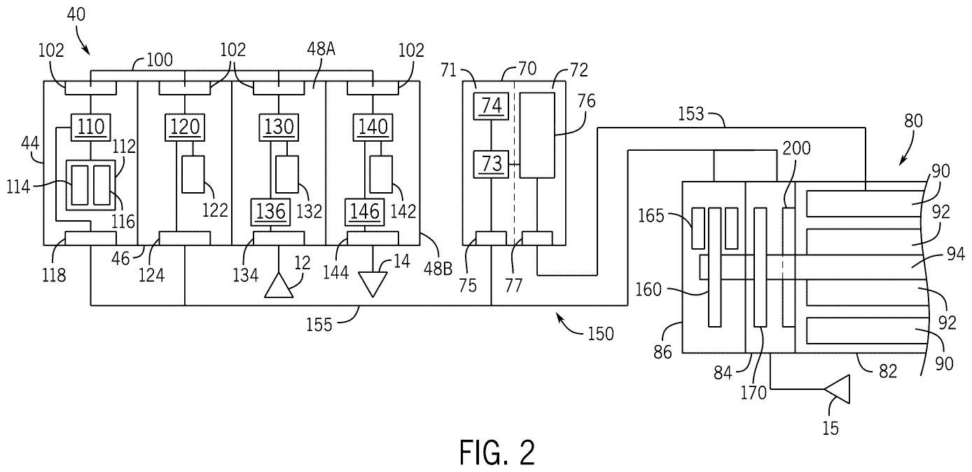

An industrial controller 40 is mounted within the second control cabinet 22. The industrial controller 40 is configurable and includes multiple modules with a backplane 100 (see also FIG. 2) extending between and providing communication between the modules. The modules may be installed within a housing or on a mounting bracket, such as a DIN rail. The illustrated industrial controller 40 includes a power supply module 42, a processor module 44, a network module 46, and one I/O module 48. The network module 46, processor module 44, or a combination thereof may communicate on an industrial control network 150 (see also FIG. 2), such as ControlNet®, DeviceNet®, or EtherNet/IP®, between the industrial controller 40 and other devices connected to the industrial controller. The industrial network 150 includes network media 155, which may be wired, wireless, or a combination thereof, connecting devices for communication on the industrial network. The industrial controller 40 may be, for example, a programmable logic controller (PLC), a programmable automation controller (PAC), or the like. It is contemplated that the industrial controller 40 may include still other modules, such as an axis control module, various numbers and arrangements of each of the illustrated modules, or additional racks connected via the industrial control network 150. Optionally, the industrial controller 40 may have a fixed configuration, for example, with a predefined number of network and I/O connections. The I/O module 48 receives input signals from sensors 12 or other devices present on the controlled machine or process 10 and transmits output signals to actuators 14 or other devices also present on the controlled machine or process.

Also shown in the second control cabinet 22 are two cabinet mounted motor drives 50. The cabinet mounted motor drives 50 are in communication with the industrial controller 40 to receive motion commands for motors 60 connected to the motor drives 50. Wiring 55 must also be run from the cabinet mounted motor drives 50 to the motors 60. For ease of illustration, a single block represents all of the wiring 55 extending between the control cabinets 22 and the controlled machine or process 10. It is understood that the wiring 55 would run to multiple locations and for multiple distances ranging from tens to hundreds of feet. Wires may be run individually, in bundles, as a cable, in cable trays, conduits, or in any other suitable manner according to the application requirements. A cabinet mounted motor drive 50 typically includes power wires and control wires extending between the motor drive 50 and the motor 60. The power wires supply the desired voltage and current to cause rotation of the motor 60 and the control wires may be input signals, such as encoder feedback, or output signals, such as brake control commands. The illustrated motor 60 includes a motor chassis 62 containing the stator and rotor of the motor as well as an encoder 64 and a brake unit 66 mounted to the motor chassis 62.

In some applications, a motor drive may be mounted directly on a motor. As further illustrated in FIG. 1, an integrated motor drive 70 is fixed to a motor 80. Power is still provided to the integrated motor drive 70. However, other wiring, such as the control wiring and power wires supplying the desired voltage and current to cause rotation of the motor 80 are significantly reduced between the motor drive 70 and the motor 80. Mounting the motor drive 70 on the motor 80 reduces the potential for noise from other devices interfering with the signals between the motor 80 and the motor drive 70. Mounting the motor drive 70 on the motor 80 also reduces the radiated emissions generated by the wiring between the motor drive and the motor that may create a potential for interference with other devices. The illustrated motor 80 includes a motor chassis 82 containing the stator 90 and rotor 92 (see also FIG. 2) of the motor as well as an encoder 84 and a brake unit 86 mounted to the motor chassis 82. As further illustrated, one or more sensors 15 may be mounted proximate to the motor 80 and may provide input signals to the motor 80.

Turning next to FIG. 2, a portion of the control system 20 is illustrated in more detail. The processor module includes a processor 110 communicating with a memory device 112 to execute an operating system program 114, generally controlling the operation of the processor module 44, and a control program 116, describing a desired control of the industrial machine or process 10, where each control program 116 is typically unique to a given application of the industrial control system 20. The memory 112 may also include data tables, for example, I/O tables and service routines (not shown in FIG. 2) as used by the control program 116. The processor module 44 communicates via a bus, illustrated as a backplane 100 extending between backplane connectors 102, with the network module 46 or any of the other modules 48 in the industrial controller 40.

The network module 46 includes a control circuit 120, which may include a microprocessor and a program stored in memory 122 and/or dedicated control circuitry such as an application specific integrated circuit (ASIC) or field programmable gate array (FPGA). The control circuit 120 is in communication with the other modules in the industrial controller via the backplane connector 102 and the backplane 100. The control circuit 120 may communicate with a network interface circuit 124 within the network module 46, where the network interface circuit 124 provides for execution of low-level electrical protocols on the industrial control network 150.

A first I/O module 48A is illustrated as an input module, configured to receive input signals from sensors 12 or other devices in the controlled machine or process 10. The first I/O module 48A includes a control circuit 130, which may include a microprocessor and a program stored in memory 132 and/or dedicated control circuitry such as an application specific integrated circuit (ASIC) or field programmable gate array (FPGA). The control circuit 130 is in communication with the other modules in the industrial controller via the backplane connector 102 and the backplane 100. The control circuit 130 is also in communication with a logic interface circuit 136, where the logic interface circuit converts input signals received from the sensors 12 via terminals 134 on the input module 48A into digital signals for use by the control circuit 130.

A second I/O module 48B is illustrated as an output module, configured to transmit output signals to actuators 14 or other devices in the controlled machine or process 10. The second I/O module 48B includes a control circuit 140, which may include a microprocessor and a program stored in memory 142 and/or dedicated control circuitry such as an application specific integrated circuit (ASIC) or field programmable gate array (FPGA). The control circuit 140 is in communication with the other modules in the industrial controller via the backplane connector 102 and the backplane 100. The control circuit 140 is also in communication with a logic interface circuit 146, where the logic interface circuit converts digital signals from the control circuit 140 to output signals for transmission to the actuators 14 via terminals 144 on the output module 48B.

Each motor drive 70 includes a control section 71 and a power section 72. The power section 72 includes components typically handling, for example, 200-575 VAC or 200-800 VDC. The power section 72 receives power in one form and utilizes power switching devices 76 to regulate power output to the motor 80 in a controlled manner to achieve desired operation of the motor. Cabling 153 connects power output terminals 77 of the motor drive 70 to supply the generated output voltage to the motor 80. The control section 71 includes components typically handling, for example 110 VAC or 3.3-50 VDC. The control section 71 includes processing devices, feedback circuits, and supporting logic circuits to receive feedback signals and generate control signals within the motor drive 70. The illustrated embodiment includes a processor 73 in communication with memory 74. The processor receives data from the industrial network 150 via a communication interface 75. The data includes, for example, commands from the industrial controller 40 corresponding to desired operation of the motor. The processor 73 executes one or modules to control operation of the switching devices 76 to generate a desired output voltage to achieve desired operation of the motor 80. The description above of a motor mounted motor drive 70 similarly applies to the cabinet mounted motor drives 50.

FIG. 2 further illustrates a portion of the elements included in a brake module 86 and an encoder 84 mounted to the motor chassis 82. A motor shaft 94 extends through the center of the motor 80. One end of the motor shaft 94 extends from the front of the motor 80 and is coupled to a gearbox, pulley, or other drive member to achieve desired operation of one axis of the controlled machine or process 10. The other end of the motor shaft 94 extends from the rear of the motor chassis 82 for coupling to the encoder 84 and brake 86. The brake 86 may be a disc brake, where a disc 160 is mounted to the motor shaft 94 and calipers 165 are controlled to selectively engage the disc to set and release the brake 86. The encoder may include a graduated disc 170 mounted to the motor shaft 94, where sensors read the gradations present on the disc 170 to detect an angular position of the motor 80. According to the illustrated embodiment, the encoder 84 also includes a printed circuit board (PCB) substrate 200 within the encoder.

In operation, a control program 116, executing on the processor module 44 is configured to command cyclic operation of the motor 80. The control program 116 generates a command, or reference signal, for desired operation of each motor 80. According to one aspect of the invention, the control program 116 may be configured to output a desired motion profile for the motor 80. According to another aspect of the invention, one of the other modules 48 for the industrial controller 40 is configured to generate motion profiles for each motor 80. According to yet another option, the control program 116 generates a command, such as start or stop, with a desired speed and/or acceleration at which the motor 80 is to travel. As still another option, the control program 116 may identify a desired station and/or location to which a motor 80 is to drive an object. The control program 116 is in communication with the motor drive 70 to transmit the desired operation of the motor 80 to the motor drive 70. The desired operation may be a motion profile at which the motor 80 is to rotate. Optionally, the desired speed and/or acceleration or a desired position to which the motor 70 is to be rotated may be transmitted. The motor drive 70 may then convert the commanded operation to a motion profile for the motor 80.

The control program 116 may also be utilized to generate a cycle start signal corresponding to the start of each cycle of operation for the motor 80. According to one aspect of the invention, the cycle start signal may be generated by a sensor present on the controlled machine or process 10. The sensor may generate a signal, for example, when a container is detected by a proximity sensor. The container may be filled, labeled, closed, or some other action taken which requires cyclic operation of the motor 80 each time a new container is detected. The sensor signal may be used as the cycle start signal. According to another aspect of the invention, the cycle start signal may be generated by an internal status bit within the control program 116. The control program 116 may, for example, define a series of steps to be performed in a predefined order. One or more of the steps may require cyclic operation of the motor 80 for completion, and the cyclic operation may begin execution at the appropriate point within each sequence of steps. The internal status bit which triggers the cyclic operation may be utilized as the cycle start signal.

According to still another aspect of the invention, either the industrial controller 40 or the motor drive 70 may detect cyclic operation and generate a cycle start signal. The industrial controller 40 may be configured to monitor signals for repeated operation. If, for example, a feedback signal or an internal signal is active or activated for the same duration at the same interval, the industrial controller 40 determines that the operation is cyclic in nature. The industrial controller 40, in turn, generates a cycle start signal or utilizes the monitored signal as a cycle start signal. The motor drive 70 may be better suited to detect cyclic operation. The motor drive 70 is configured to control operation of a motor 80 and receives a command signal corresponding to desired operation of the motor 80. The motor drive 70 is monitoring a single or limited number of command signals and operation of the motor 80 connected to the motor drive 70. If the command signal is generated at a repeated interval and/or the motor 80 operates in a repeated pattern over a duration of time, the motor drive 70 determines that the motor 80 is being controlled in a cyclic manner. The motor drive 70, in turn, may generate a cycle start signal corresponding to a common point within each cycle of operation.

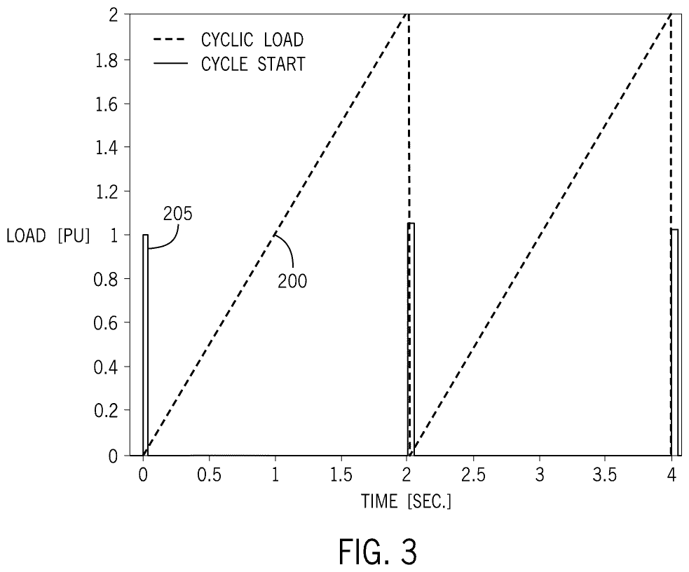

With reference also to FIG. 3, an exemplary cyclic load is illustrated. The illustrated load 200 is sawtooth in nature, beginning at no load, or zero per unit, and ramping up in a linear manner to two hundred percent, or two per unit, over a two second interval. The illustrated load 200 then returns to zero and repeats the pattern every two seconds. A cycle start signal 205 is generated at the start of each cycle when the load is at zero per unit. The illustrated load is intended to be exemplary and not limiting. It is understood that the load may vary in a non-linear fashion throughout the cycle. Similarly, a load may start and stop one or more times within a cycle. The type of load may vary, but the nature of the load is that it repeats at a periodic interval, where a cycle start signal 205 may be generated at the beginning of each periodic interval.

The motor 80 being controlled to execute at the periodic interval may have a maximum steady state rating. For example, the motor 80 may be configured to run at a first predefined number of amps continuously or at a second predefined number of amps, where the second predefined number of amps is greater than the first predefined number of amps, for a short duration. The first rating may be referred to as a continuous rating, and the second rating may be referred to as an overload rating. If the motor 80 is operating in an application where a constant load is applied at a constant speed, it is easy to determine whether the motor 80 is sized appropriately for the application. During operation, a motor drive 70 measures the current being drawn by the motor and determines whether the current exceeds either the continuous rating or the overload rating. If the current is less than the continuous rating, then the motor drive 70 determines the motor 80 is operating at a safe capacity. If the current is greater than a continuous rating, the motor drive 70 may monitor the current for a duration associated with the overload rating. If the motor 80 runs at the elevated current for a time greater than the duration associated with the overload rating, the motor drive 70 sets an alarm or fault message accordingly.

In other applications, the load and/or speed at which the motor operates varies over time. It is more difficult to determine whether the motor 80 is appropriately sized. As the motor 80 operates, the motor windings and/or housing may gradually increase in temperature due to the current drawn through the motor for operation. However, during periods of time where the motor 80 stops or operates at low current levels, the temperature in the motor may decrease. If periodic operation changes speeds and/or starts and stops operation of the motor 80, the rate at which the motor changes temperature varies as well. The motor 80 has a time constant at which the motor reaches a steady state temperature. However, the time constant may be several minutes and a time constant, by definition, requires the motor 80 to operate for multiple instances of the time constant at a constant operating condition for the motor 80 to reach steady state operation. When the motor 80 is operating under a varying operation profile, the duration for the motor 80 to reach steady state operation is extended. Further, it is difficult to determine whether the motor 80 will exceed a safe operating range until steady state operation is reached.

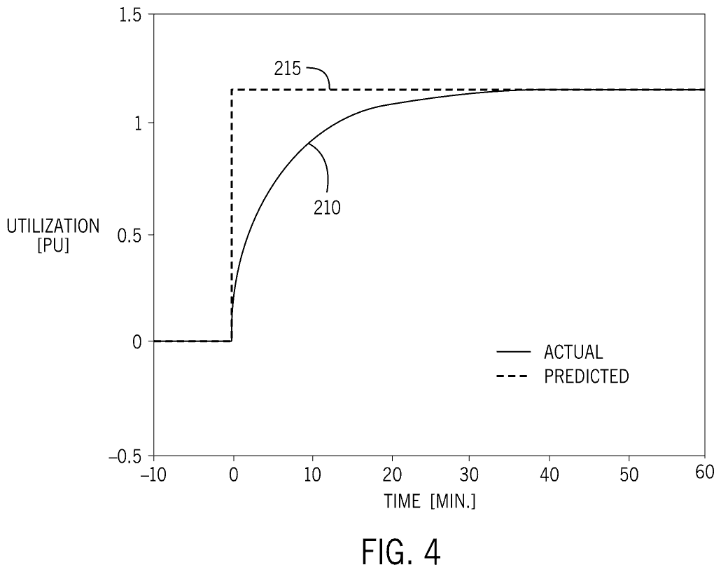

In an application where the motor 80 executes the same operation profile at a periodic interval, the present invention provides real-time determination of whether the motor 80 is properly sized for the application after a single cycle of operation. Turning next to FIG. 4, an example of device utilization prediction according to the present invention is illustrated. A first plot 210 illustrates an actual, measured operating state for the controlled system as a result of the motor 80 executing the variable profile at a periodic interval. The measured operating state will reach about one hundred twenty percent, or about 1.2 pu, utilization under continued operation of the controller motor 80 according to the periodic operation profile. As illustrated, however, it takes approximately fifty minutes to reach this steady state operating state. As also illustrated, the present invention generates a predicted level of the steady state operating state after a single cycle of operation. A second plot 215 shows the predicted value of the steady state condition for the measured operating state. The predicted value, determined one cycle after operation starts, accurately predicts the steady state operation of the motor 80 fifty minutes later.

Operation at above the one hundred percent level under steady state operation may not be desirable. Therefore, based on the illustrated utilization profile, the operation profile should be changed to achieve operation at or below the one hundred percent level. Without the real-time prediction, the motor 80 must be allowed to operate until it reaches steady state. Upon determining that the steady-state operation is undesirable, the operation profile is adjusted, for example, by reducing a speed of operation, an acceleration rate, or some other parameter corresponding to operation of the motor 80. The motor 80 must return to its initial operating condition or, at a minimum, to some reduced value of the measured operating condition, where the measured operating condition may be, for example, temperature. Once the motor 80 is at an initial or reduced value, the motor 80 is again operated according to the periodic operation profile until a new steady-state operating condition is reached. This process may need to be repeated multiple times until an acceptable set of parameters and an acceptable steady state operating condition is reached. Due to the extended time constant, this process may take several hours, or potentially multiple days to complete setup and configuration.

In contrast, by providing a predicted value of the steady state operating condition, the controlled machine or process 10, or portion thereof, may be run for a single cycle of operation. A technician may observe the predicted value of the steady state operating condition and determine whether this predicted value is at an acceptable level. If a change is required for a parameter in the motor drive 70 or within the control program 116 to adjust the operation profile, this change may be made after one cycle of operation and another cycle of operation is executed. A new predicted value of the steady state operating condition is generated after the next cycle of operation with the new parameter settings and/or new operation profile. The technician may again observe the second predicted value and determine whether this new predicted value is at an acceptable level. Because a predicted value for each set of parameters is obtained after only a single cycle, a technician may configure operation of the controlled machine or process to rapidly obtain a desired operating performance that is within the ratings of the motor 70 or other measured operating state without waiting for the entire duration required to reach steady state operation after each configuration change.

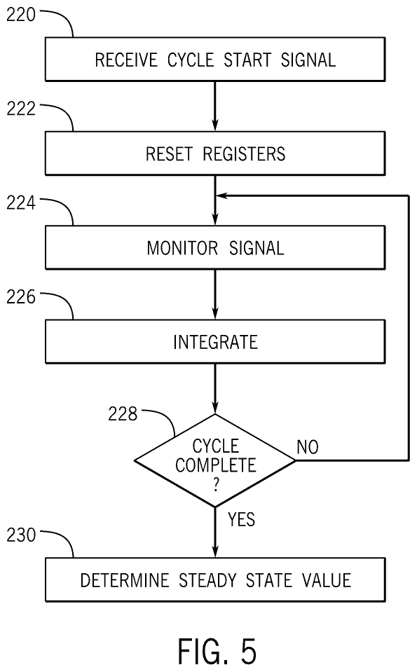

With reference next to FIG. 5, steps for predicting steady state operation according to one embodiment of the invention are illustrated. For purposes of discussion, a motor drive 70 configured to control operation of a motor 80 is used to determine utilization of the motor. At step 220, a cycle start signal is received. The cycle start signal may be generated by an industrial controller 40 in communication with the motor drive 70 and transmitted to the motor drive. Registers used for determining device utilization from a prior cycle are reset at step 222 At step 224 the signal of interest is monitored. The signal of interest may be a feedback signal, corresponding to the operating state being monitored. The feedback signal is measured and a value of the feedback signal is provided to the processor 73 in the motor drive 70. Optionally, a reference signal, or other internal signal, generated by execution of the motor drive 70 is the signal of interest. The processor 73 reads a present value of the reference signal and uses the present value of the reference signal to determine device utilization. According to one aspect of the invention, the steady state utilization of the monitored signal corresponds to an average value for the same signal over a single cycle. As shown in step 226, the monitored signal is integrated over the course of the cycle of operation. The instructions executing within the motor drive 70 will execute at a rate that is typically an order of magnitude, or multiple orders of magnitude, faster than the physical cycle of operation of the controlled machine or process. Thus, multiple samples of the monitored signal are obtained within the motor drive 70 during one cycle of operation of the controlled machine or process. At step 228, the motor drive waits for the physical cycle of operation to be complete. If the cycle is not complete, the motor drive 70 continues measuring and integrating the monitored signal. When the cycle is complete, the motor drive 70 determines the steady state value of the monitored signal, as shown in step 230. The steady state value of the monitored signal may be determined by finding an average value of the integrated value of the monitored signal over the duration of one cycle of operation.

It is another aspect of the invention, that the measured value of the monitored signal is first squared prior to integration. Squaring the value eliminates a need to handle a sign, or polarity, of the feedback signal. The integrated value is divided by two, and a square root of the result is taken to compensate for the initial squaring of the value. The final value determined, corresponds to the value of the monitored signal when the controlled machine or process 10 reaches steady state operation. Thus, the steady state device utilization of the monitored signal is determined in real-time over a single cycle of operation without waiting for the controlled device or system to reach the steady state operating condition.

The industrial control system 20 controlled by the industrial controller 40 may be a complex system. Multiple controlled signals may interact with each other to determine a steady state operating condition for the controlled system. The above described steps for monitoring a single signal may be duplicated for multiple feedback signals and/or multiple reference signals. According to one aspect of the invention, the motor drive 70 may include a model of a system controlled by the motor 80 connected to the motor drive 70. The model may include, for example, an angular velocity reference signal for the motor, a temperature of the controlled system, output current produced by the motor 80, position feedback signals from the encoder 84 mounted to the motor, and the like. Each of the signals for the model may be monitored over a single cycle of operation in the controlled system and the average value of each monitored signal provided to the model. The model may, in turn, be used to determine a steady state operating condition of the controlled system as a function of multiple monitored signals.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A method for real-time determination of steady state device utilization, comprising the steps of:
receiving a cycle start signal at a controller for a controlled device;
measuring a feedback signal from a sensor configured to monitor the controlled device through a cycle of operation, wherein the feedback signal corresponds to an operating state of the controlled device;
obtaining an average value of the feedback signal for the cycle of operation; and
determining the steady state device utilization of the controlled device, wherein the controlled device achieves the steady state device utilization over a plurality of future cycles and wherein the steady state device utilization is determined in real-time as a function of an average value obtained during the cycle of operation for which the feedback signal is measured.

2. The method of claim 1, further comprising the step of:
generating an operation profile that varies at a periodic interval, wherein:
the cycle start signal is generated at a common time during each of the periodic intervals,
the cycle of operation corresponds to one periodic interval, and
the operation profile varies in a common pattern during each periodic interval.

3. The method of claim 2, wherein:
the controlled device is a motor,
the controller is a motor drive operatively connected to the motor to control operation of the motor, and
the operation profile is a motion profile for the motor, the method further comprising the steps of:
generating the cycle start signal at a beginning of each periodic interval, and
generating an output voltage with the motor drive that varies in amplitude or frequency in the common pattern during each periodic interval to achieve the motion profile.

4. The method of claim 3, wherein:
another controller, external from the motor drive, generates the operation profile and the cycle start signal, the method further comprising the step of:
transmitting the operation profile and the cycle start signal from the other controller to the motor drive.

5. The method of claim 3, further comprising the steps of:
detecting a periodic cycle in the motion profile with the motor drive; and
generating the cycle start signal in the motor drive at the start of the periodic cycle detected.

6. The method of claim 3, wherein:
the motor drive includes a plurality of parameters, wherein each of the plurality of parameters defines, at least in part, operation of the motor as a function of the motion profile, and
determining the steady state device utilization of the controlled device over the plurality of future cycles as a function of the average value during the cycle of operation for which the feedback signal is measured determines a first steady state device utilization as a function of a first set of the plurality of parameters, the method further comprising the steps of:
changing a value of one of the plurality of parameters to generate a second set of the plurality of parameters; and
determining a second steady state device utilization of the controlled device over the plurality of future cycles as a function of the average value during the cycle of operation for which the feedback signal is measured as a function of the second set of the plurality of parameters.

7. The method of claim 1, wherein:
the operating state of the controlled device has a time constant requires a plurality of cycles of operation to reach a steady state operating state; and
determining the steady state device utilization is determined over one cycle of operation.

8. A system for real-time determination of steady state utilization of a controlled device, the system comprising:
a controlled device, wherein the controlled device receives an operation profile that varies at a periodic interval; and
a controller configured to:
receive a signal corresponding to an operating state of the controlled device,
detect a cycle start signal, wherein the cycle start signal corresponds to a beginning of the periodic interval over which the operation profile of the controlled device varies, and
determine a steady state device utilization of the controlled device, wherein:
the controlled device achieves the steady state device utilization over a plurality of future cycles, and
the steady state device utilization is determined as a function of the signal corresponding to the operating state of the controlled device measured over one cycle of operation for the controlled device.

9. The system of claim 8, wherein the controller is further configured to:
generate the operation profile for the controlled device; and
generate the cycle start signal at a common time during each of the periodic intervals.

10. The system of claim 8, wherein the controlled device is a motor, the system further comprising a motor drive connected to the motor to control operation of the motor, wherein the motor drive includes the controller and the motor drive is further operative to output a voltage that varies in amplitude or frequency in a common pattern as a function of the operation profile during each periodic interval.

11. The system of claim 10, further comprising an external controller operative to:
generate a motion profile for the motor, wherein the motion profile is the operation profile;
generate the cycle start signal; and
transmit the motion profile and the cycle start signal to the motor drive.

12. The system of claim 10, wherein the motor drive is further operative to:
detect a periodic cycle in the operation profile; and
generate the cycle start signal in the motor drive at the start of the periodic cycle detected.

13. The system of claim 10, wherein:
the motor drive includes memory configured to store a plurality of parameters, wherein each of the plurality of parameters defines, at least in part, operation of the motor as a result of receiving the operation profile;
the controller determines the steady state device utilization as a function of a first set of the plurality of parameters; and
the controller is further configured to:
receive a new value for one of the plurality of parameters to generate a second set of the plurality of parameters,
measure the signal corresponding to the operating state of the controlled device over a second cycle of operation as a function of the second set of the plurality of parameters, and
determine a second steady state device utilization of the controlled device over the plurality of future cycles as a function of the signal corresponding to the operating state of the controlled device measured over the second cycle of operation.

14. The system of claim 8, wherein the operating state of the controlled device has a time constant requiring a plurality of cycles of operation to reach a steady state operating state.

15. The system of claim 8 further comprising a sensor generating a feedback signal, wherein the feedback signal is the signal corresponding to the operating state of the controlled device.

16. A motor drive configured to control operation of a motor, the motor drive comprising:
a power section configured to output a voltage to the motor for desired operation of the motor; and
a control section configured to:
receive a command signal at a periodic interval corresponding to the desired operation of the motor;
receive a feedback signal from a sensor, wherein the feedback signal corresponds to an operating state of the motor;
detect a cycle start signal, wherein the cycle start signal corresponds to a beginning of the periodic interval; and
determine a value of the feedback signal for steady state operation, wherein:
steady state operation is achieved over a plurality of periodic intervals, and
the value of the feedback signal for steady state operation is determined after a single periodic interval.

17. The motor drive of claim 16, wherein:
the control section is further configured to receive the command signal from an external controller;
the command signal is a motion profile for the motor over the periodic interval; and
the cycle start signal is received from the external controller at a common time during each of the periodic intervals.

18. The motor drive of claim 16, wherein the motor drive is further operative to:
detect a periodic cycle in the command signal; and
generate the cycle start signal in the motor drive at the start of the periodic cycle detected.

19. The motor drive of claim 16, further comprising memory configured to store a plurality of parameters, wherein:
each of the plurality of parameters defines, at least in part, operation of the motor as a result of receiving the command signal;
the control section determines the value of the feedback signal for steady state operation as a function of a first set of the plurality of parameters; and
the control section is further configured to:
receive a new value for one of the plurality of parameters to generate a second set of the plurality of parameters, and
determine a second value of the feedback signal for steady state operation as a function of the second set of the plurality of parameters, wherein the second value is determined over a single periodic interval.

20. The motor drive of claim 16, wherein the operating state of the motor corresponding to the feedback signal has a time constant requiring a plurality of cycles of operation to reach the steady state operation.
